(19) United States
(12) Patent Application Publication
(10) Pub. No.: US 2003/0172781 A1
(43) Pub. Date: Sep. 18, 2003

(54) Tool

(76) Inventor: Todd R. Saunders, Spring Lake, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/390,800

(22) Filed: Mar. 18, 2003

Related U.S. Application Data
(60) Provisional application No. 60/365,397, filed on Mar. 18, 2002.

(51) Int. Cl. B25B 13/02

(52) U.S. Cl. 81/119

(57) ABSTRACT

An open end wrench includes an integral head having a transverse extension for engaging threaded nuts or the like. Adjustable open end wrenches and pliers, including locking pliers and pipe wrenches having transverse extensions are also included.

### CROSS-REFERENCED TO RELATED APPLICATIONS

This application claims the benefit of U.S. Provisional Application No. 60/365,397, entitled TOOLS, filed Mar. 18, 2002, the entire contents of which are incorporated by reference.

### BACKGROUND OF THE INVENTION

Various types of pliers, crescent wrenches, pipe wrenches, open ended wrenches, and the like have been developed to enable a user to torque, for example, threaded fasteners. However, known pliers and the like may not be readily usable in situations wherein access to the fastener is limited.

### SUMMARY OF THE INVENTION

One aspect of the present invention is an open end wrench having an integral head and a conventional handle. The head includes an offset, transversely extending portion. Another aspect of the present invention is a pliers having a pair of jaws, each including an offset portion. Yet another aspect of the present invention is an adjustable open end and closed end wrench having an offset end portion on the jaws.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a plan view of an open end wrench according to one aspect of the present invention;

FIG. 2 is a partially fragmentary view illustrating the wrench of FIG. 1 in use;

FIG. 3 is a partially fragmentary view illustrating another version of the wrench of FIG. 1 in use;

FIG. 4 is a perspective view of an alternate embodiment of an open end wrench;

FIG. 5 is a perspective view of an alternate embodiment of an open end wrench;

FIG. 6 is a perspective view of an alternate embodiment of an open end wrench;

FIG. 7 is a perspective view of an alternate embodiment of an open end wrench;

FIG. 8 is a perspective view of a ratchet wrench wherein the socket is permanently connected to the wrench;

FIG. 9 is a perspective view of an alternate embodiment of a ratchet wrench of FIG. 8;

FIG. 10 is a perspective view of an alternate embodiment of a ratchet wrench of FIG. 8;

FIG. 11 is a perspective view of an alternate embodiment of a ratchet wrench of FIG. 8;

FIG. 12 is a perspective view of a multiple size, open end wrench having an offset portion;

FIG. 13 is a perspective view of another embodiment of a multiple size, open end wrench having an offset portion;

FIG. 14 is a perspective view of another embodiment of a multiple size, open end wrench having an offset portion;

FIG. 15 is a perspective view of another embodiment of a multiple size, open end wrench having an offset portion;

FIG. 16 is a plan view of an adjustable open end wrench having offset portions on the jaws;

FIG. 17 illustrates a first embodiment of the wrench of FIG. 16 in use;

FIG. 18 illustrates a second embodiment of the wrench of FIG. 16 in use;

FIG. 19 is a perspective view of another embodiment of an adjustable open end wrench;

FIG. 20 is a perspective-view of another embodiment of an adjustable open end wrench;

FIG. 21 is a perspective view of another embodiment of an adjustable open end wrench;

FIG. 22 is a perspective view of another embodiment of an adjustable open end wrench;

FIG. 23 is a perspective view of an adjustable wrench including an offset portion configured to engage fasteners and the like;

FIG. 24 is a perspective view of an adjustable wrench including an offset portion configured to engage fasteners and the like;

FIG. 25 is a perspective view of an adjustable wrench including an offset portion configured to engage fasteners and the like;

FIG. 26 is a perspective view of an adjustable wrench including an offset portion configured to engage fasteners and the like;

FIG. 27 is a plan view of a pipe wrench having offset jaw portions;

FIG. 28 is a side view of the pipe wrench of FIG. 27;

FIG. 29 is a plan view of another embodiment of a pipe wrench having offset jaw portions;

FIG. 30 is a side view of the pipe wrench of FIG. 29;

FIG. 31 is a plan view of another embodiment of a pipe wrench having offset jaw portions;

FIG. 32 is a side view of the pipe wrench of FIG. 31;

FIG. 33 is a plan view of a pipe wrench including offset jaw portions;

FIG. 34 is a partially fragmentary side view illustrating one embodiment of the wrench of FIG. 33 in use;

FIG. 35 is a partially fragmentary side view illustrating one embodiment of the wrench of FIG. 33 in use;

FIG. 36 is a plan view of another embodiment of a pipe wrench including offset jaw portions;

FIG. 37 is a partially fragmentary view showing another embodiment of the pipe wrench of FIG. 36 in use;

FIG. 38 is a partially fragmentary view showing another embodiment of the pipe wrench of FIG. 36 in use;

FIG. 39 is a perspective view of another embodiment of a pipe wrench having offset jaw portions;

FIG. 40 is a perspective view of another embodiment of a pipe wrench having offset jaw portions;

FIG. 41 is a perspective view of another embodiment of a pipe wrench having offset jaw portions;

FIG. 42 is a perspective view of another embodiment of a pipe wrench having offset jaw portions;

FIG. 43 is a perspective view of a pliers having offset jaw portions;

FIG. 44 is a partially fragmentary view showing two different embodiments of the pliers of FIG. 43 in use;

FIG. 45 is a perspective view of another embodiment of pliers having offset jaw portions;

FIG. 46 is a perspective view of another embodiment of pliers having offset jaw portions;

FIG. 47 is a perspective view of another embodiment of pliers having offset jaw portions;

FIG. 48 is a perspective view of another embodiment of pliers having offset jaw portions;

FIG. 49 is a perspective view of another embodiment of pliers having offset jaw portions;

FIG. 50 is a perspective view of another embodiment of pliers having offset jaw portions;

FIG. 51 is a perspective view of another embodiment of pliers having offset jaw portions;

FIG. 52 is a perspective view of another embodiment of pliers having offset jaw portions;

FIG. 53 is a plan view of a pliers having offset jaw portions;

FIG. 54 is a side view of the pliers of FIG. 53;

FIG. 55 is a plan view of another embodiment of the pliers of FIG. 53;

FIG. 56 is a side view illustrating the embodiment of FIG. 55;

FIG. 57 is a plan view illustrating yet another embodiment of the pliers of FIG. 53;

FIG. 58 is a side view of the pliers of FIG. 57;

FIG. 59 is a plan view of another embodiment of pliers including offset tip portions of the jaws;

FIG. 60 is a side view of the pliers of FIG. 59;

FIG. 61 is a plan view of another embodiment of the pliers;

FIG. 62 is a side view of another embodiment of the pliers;

FIG. 63 is a plan view illustrating yet another embodiment of the pliers;

FIG. 64 is a side view of the pliers of FIG. 63;

FIG. 65 is a plan view of pliers including offset jaw portions;

FIG. 66 is a partially fragmentary view illustrating an embodiment of the pliers in use;

FIG. 67 is a partially fragmentary view illustrating another embodiment of the pliers in use;

FIG. 68 is a perspective view illustrating another embodiment of pliers having offset jaw portions;

FIG. 69 is a perspective view illustrating another embodiment of pliers having offset jaw portions;

FIG. 70 is a perspective view illustrating another embodiment of pliers having offset jaw portions;

FIG. 71 is a perspective view illustrating another embodiment of pliers having offset jaw portions;

FIG. 72 is a perspective view illustrating another embodiment of pliers having offset jaw portions;

FIG. 73 is a perspective view illustrating another embodiment of pliers having offset jaw portions;

FIG. 74 is a perspective view illustrating another embodiment of pliers having offset jaw portions;

FIG. 75 is a perspective view illustrating another embodiment of pliers having offset jaw portions;

FIG. 76 is a perspective view illustrating another embodiment of pliers having offset jaw portions;

FIG. 77 is a perspective view illustrating another embodiment of pliers having offset jaw portions;

FIG. 78 is a perspective view illustrating another embodiment of pliers having offset jaw portions;

FIG. 79 is a perspective view illustrating another embodiment of pliers having offset jaw portions;

FIG. 80 is a perspective view illustrating another embodiment of pliers having offset jaw portions;

FIG. 81 is a perspective view illustrating another embodiment of pliers having offset jaw portions;

FIG. 82 is a perspective view illustrating another embodiment of pliers having offset jaw portions;

FIG. 83 is a perspective view illustrating another embodiment of pliers having offset jaw portions;

FIG. 84 is a perspective view illustrating another embodiment of pliers having offset jaw portions;

FIG. 85 is a perspective view illustrating another embodiment of pliers having offset jaw portions;

FIG. 86 is a perspective view illustrating another embodiment of pliers having offset jaw portions;

FIG. 87 is a perspective view illustrating another embodiment of pliers having offset jaw portions;

FIG. 88 is a plan view of another embodiment of adjustable pliers having offset jaw portions;

FIG. 89 is a partially fragmentary view illustrating an embodiment of the pliers of FIG. 88 in use;

FIG. 90 is a partially fragmentary view illustrating an embodiment of the pliers of FIG. 88 in use;

FIG. 91 is a perspective view of another embodiment of pliers having offset jaw portions;

FIG. 92 is a perspective view of another embodiment of pliers having offset jaw portions;

FIG. 93 is a perspective view of another embodiment of pliers having offset jaw portions;

FIG. 94 is a perspective view of another embodiment of pliers having offset jaw portions;

FIG. 95 is a perspective view of another embodiment of pliers having offset jaw portions;

FIG. 96 is a perspective view of another embodiment of pliers having offset jaw portions;

FIG. 97 is a perspective view of another embodiment of pliers having offset jaw portions;

FIG. 98 is a perspective view of another embodiment of pliers having offset jaw portions;

FIG. 99 is a perspective view of a pliers according to another aspect of the present invention including offset jaws configured to grip relatively large objects;

FIG. 100 is a perspective view of a pliers according to another aspect of the present invention including offset jaws configured to grip relatively large objects;

FIG. 101 is a perspective view of another embodiment of pliers having offset jaw portions;

FIG. 102 is a perspective view of a pliers according to another aspect of the present invention including offset jaws configured to grip relatively large objects;

FIG. 103 is a plan view of a locking pliers including offset jaw portions according to yet another aspect of the present invention;

FIG. 104 is a partially schematic view illustrating an embodiment of the locking pliers of FIG. 103 in use;

FIG. 105 is a partially schematic view illustrating an embodiment of the locking pliers of FIG. 103 in use;

FIG. 106 is a perspective view of another embodiment of locking pliers including offset jaw portions;

FIG. 107 is a perspective view of another embodiment of locking pliers including offset jaw portions;

FIG. 108 is a perspective view of another embodiment of locking pliers including offset jaw portions;

FIG. 109 is a perspective view of another embodiment of locking pliers including offset jaw portions;

FIG. 110 is a plan view of locking pliers including offset jaw portions;

FIG. 111 is a partially fragmentary view illustrating an embodiment of the locking pliers of FIG. 110 in use;

FIG. 112 is a partially fragmentary view illustrating an embodiment of the locking pliers of FIG. 110 in use;

FIG. 113 is a perspective view of another embodiment of locking pliers including offset jaw portions;

FIG. 114 is a perspective view of another embodiment of locking pliers including offset jaw portions;

FIG. 115 is a perspective view of another embodiment of locking pliers including offset jaw portions;

FIG. 116 is a perspective view of another embodiment of locking pliers including offset jaw portions;

FIG. 117 is a perspective view of another embodiment of locking pliers including offset jaw portions;

FIG. 118 is a perspective view of another embodiment of locking pliers including offset jaw portions;

FIG. 119 is a perspective view of another embodiment of locking pliers including offset jaw portions;

FIG. 120 is a perspective view of another embodiment of locking pliers including offset jaw portions;

FIG. 121 is a perspective view of another embodiment of pliers according to the present invention including offset jaw portions;

FIG. 122 is a perspective view of another embodiment of pliers according to the present invention including offset jaw portions;

FIG. 123 is a perspective view of another embodiment of pliers according to the present invention including offset jaw portions;

FIG. 124 is a perspective view of another embodiment of pliers according to the present invention including offset jaw portions;

FIG. 125 is a perspective view of another embodiment of pliers according to the present invention including offset jaw portions;

FIG. 126 is a perspective view of another embodiment of pliers according to the present invention including offset jaw portions;

FIG. 127 is a perspective view of another embodiment of pliers according to the present invention including offset jaw portions;

FIG. 128 is a perspective view of another embodiment of pliers according to the present invention including offset jaw portions;

FIG. 129 is a plan view of pinch nose pliers according to another aspect of the present invention including offset jaw portions;

FIG. 130 is a side view of the pinch nose pliers of FIG. 129;

FIG. 131 is a plan view of another embodiment of pinch nose pliers;

FIG. 132 is a side view of the pinch nose pliers of FIG. 131;

FIG. 133 is a plan view of another embodiment of pinch nose pliers;

FIG. 134 is a side view of the pinch nose pliers of FIG. 131;

FIG. 135 is a plan view of lineman's pliers according to another aspect of the present invention including offset jaw portions;

FIG. 136 is a side view of the lineman's pliers of FIG. 129;

FIG. 137 is a plan view of another embodiment of lineman's pliers;

FIG. 138 is a side view of the lineman's pliers of FIG. 131;

FIG. 139 is a plan view of another embodiment of lineman's pliers;

FIG. 140 is a side view of the lineman's pliers of FIG. 131;

FIG. 141 is a plan view of pinch nose pliers according to the present invention including offset jaw portions;

FIG. 142 is a partially schematic view illustrating the pliers of FIG. 141 in use;

FIG. 143 is a partially schematic view illustrating the pliers of FIG. 141 in use;

FIG. 144 is a perspective view illustrating another embodiment of the pliers of the present invention including offset jaw portions;

FIG. 145 is a perspective view illustrating another embodiment of the pliers of the present invention including offset jaw portions;

FIG. 146 is a perspective view illustrating another embodiment of the pliers of the present invention including offset jaw portions;

FIG. 147 is a perspective view illustrating another embodiment of the pliers of the present invention including offset jaw portions;

FIG. 148 is a perspective view illustrating another embodiment of the pliers of the present invention including offset jaw portions;

FIG. 149 is a perspective view illustrating another embodiment of the pliers of the present invention including offset jaw portions;

FIG. 150 is a perspective view illustrating another embodiment of the pliers of the present invention including offset jaw portions;

FIG. 151 is a perspective view illustrating another embodiment of the pliers of the present invention including offset jaw portions;

FIG. 152 is a perspective view illustrating another embodiment of the pliers of the present invention including offset jaw portions;

FIG. 153 is a perspective view illustrating another embodiment of the pliers of the present invention including offset jaw portions;

FIG. 154 is a perspective view illustrating another embodiment of the pliers of the present invention including offset jaw portions;

FIG. 155 is a perspective view illustrating another embodiment of the pliers of the present invention including offset jaw portions;

FIG. 156 is a perspective view illustrating another embodiment of the pliers of the present invention including offset jaw portions;

FIG. 157 is a perspective view illustrating another embodiment of the pliers of the present invention including offset jaw portions;

FIG. 158 is a perspective view illustrating another embodiment of the pliers of the present invention including offset jaw portions; and

FIG. 159 is a perspective view illustrating another embodiment of the pliers of the present invention including offset jaw portions.

### DETAILED DESCRIPTION OF PREFERRED EMBODIMENT

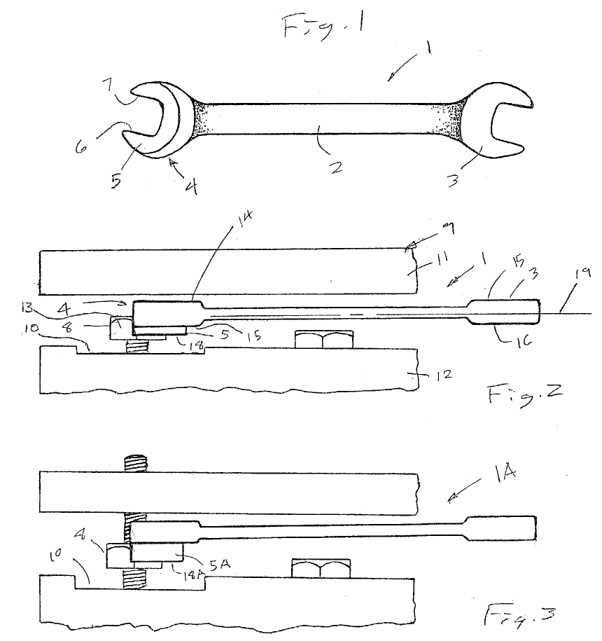

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 1 (FIG. 1) generally designates an open end wrench according to one aspect of the present invention. The wrench 1 includes an elongated conventional handle 2 and a conventional head 3. However, the wrench 1 also includes a second head 4 including a transverse extension 5. The transverse extension 5 includes generally parallel engagement surfaces 6 and 7. With further reference to FIG. 2, the extension 5 permits the wrench 1 to be utilized in situations wherein access to the hex head 8 of a nut or the like is restricted. In the illustrated example, an extrusion or fixture 9 includes a recessed channel portion 10. Furthermore, the upper portion 11 and lower portion 12 of the fixture 9 restrict access to the hex nut 8. However, the extension 5 of the wrench 1 ensures that the engagement surfaces 6 and 7 engage the flat surfaces of the hex 8 even if it is positioned within the channel 10. In the illustrated example, the extension 5 generally takes the form of a wall having a C-shape in cross section. The head 4 includes first and second side faces 14, 15, respectively that are generally parallel and space-apart in substantially the same manner as the side faces 15 and 16 of the head 3. However, the extension 5 extends transversely from the second side face 15, and defines an end face 18. The end face 18 is spaced apart from the center line 19 of the wrench 1 by an amount that is substantially greater than the distance between the faces 14, 15, 16, and the center line 19. An alternate embodiment of the open end wrench of FIG. 1 is illustrated in FIG. 3, and designated 1A. The wrench 1A includes an extension 5A that is longer than the extension 5 to permit access to hex fasteners 8 or the like in situations requiring a longer extension.

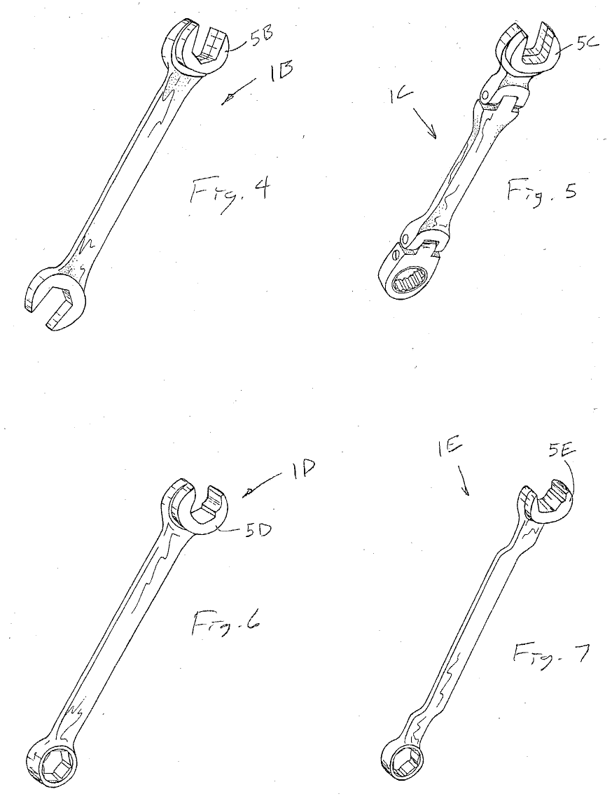

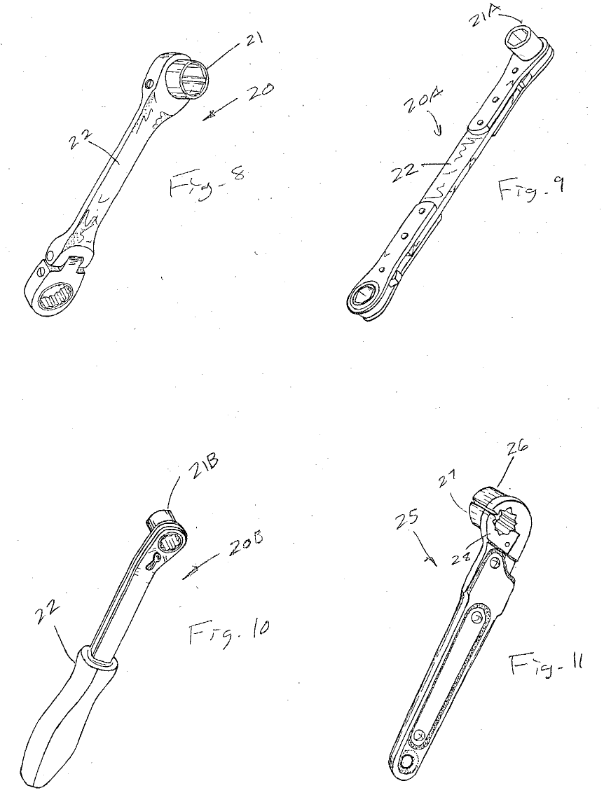

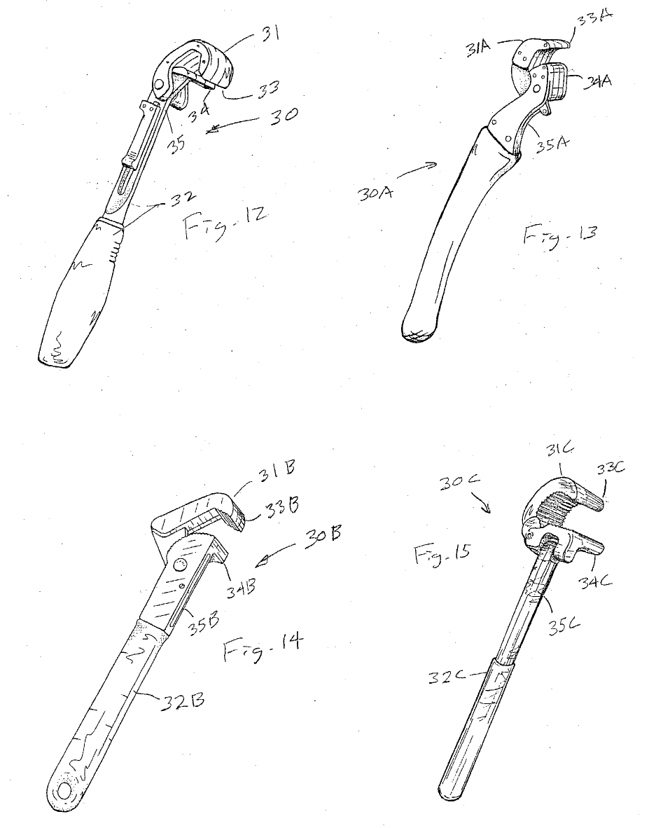

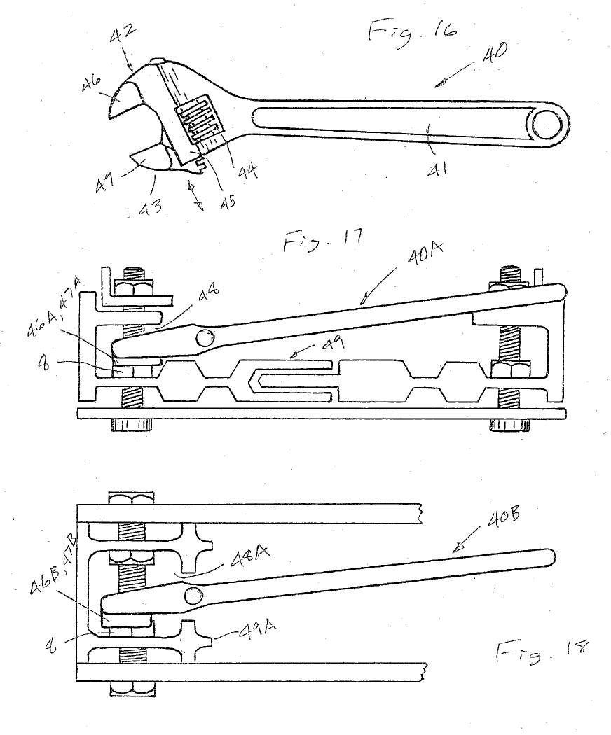

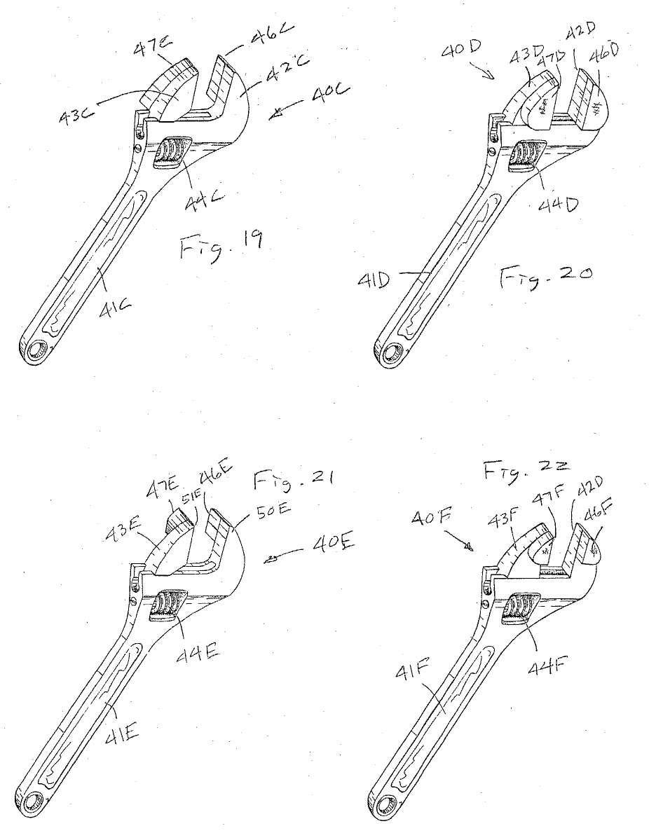

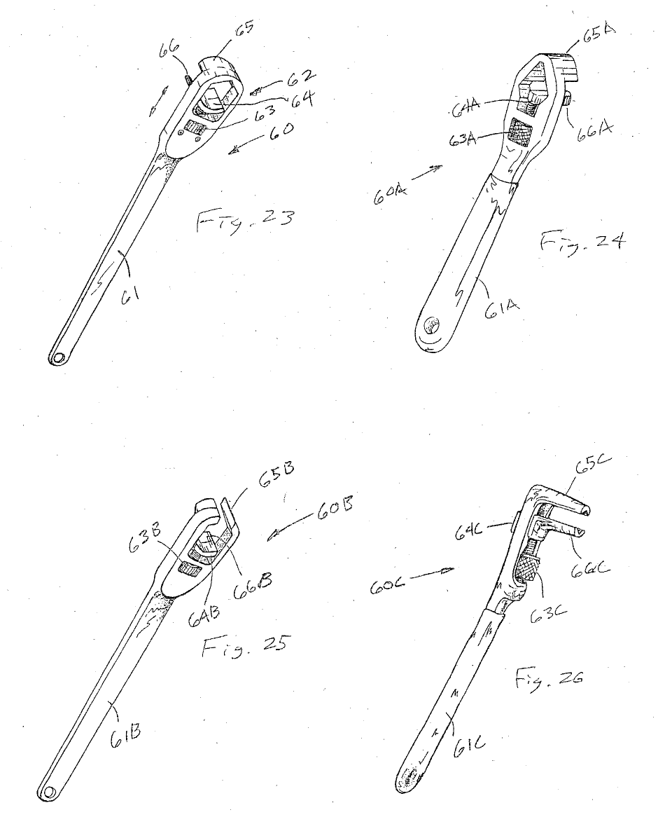

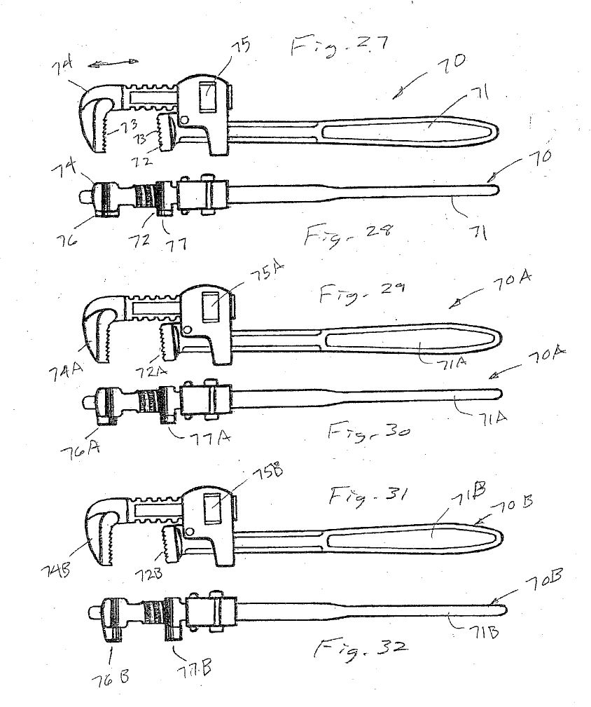

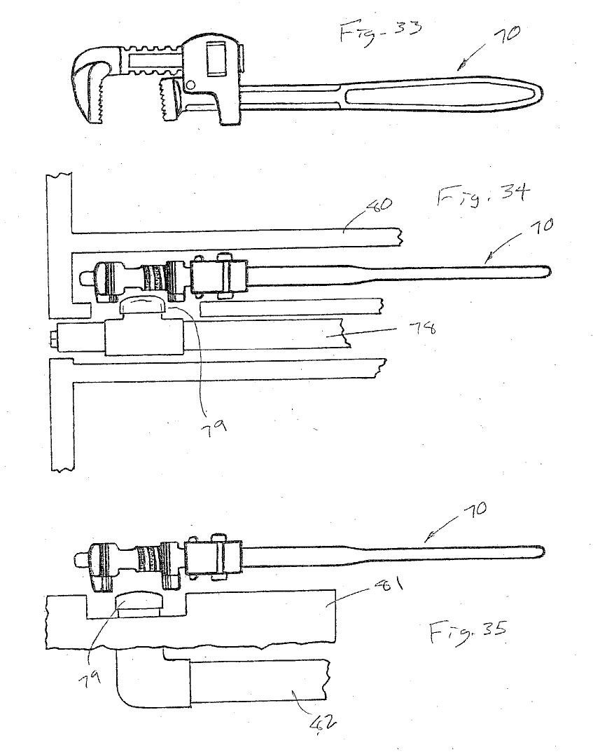

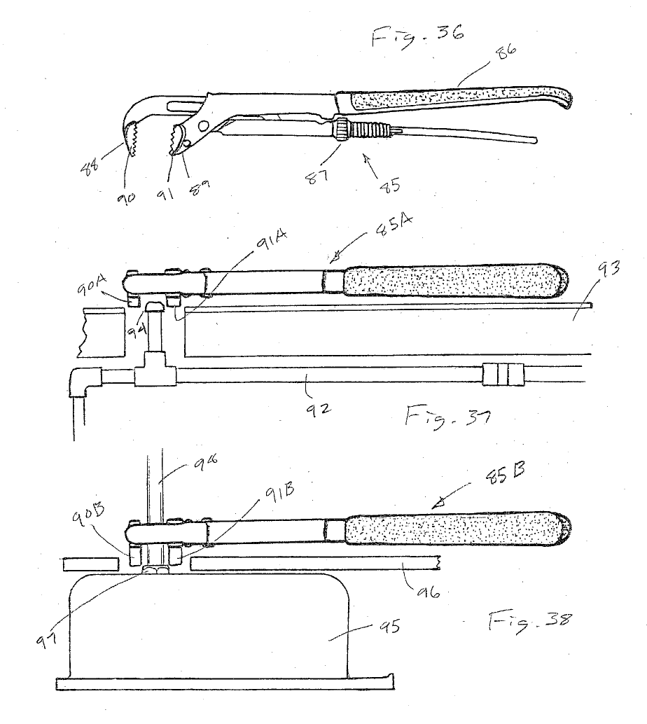

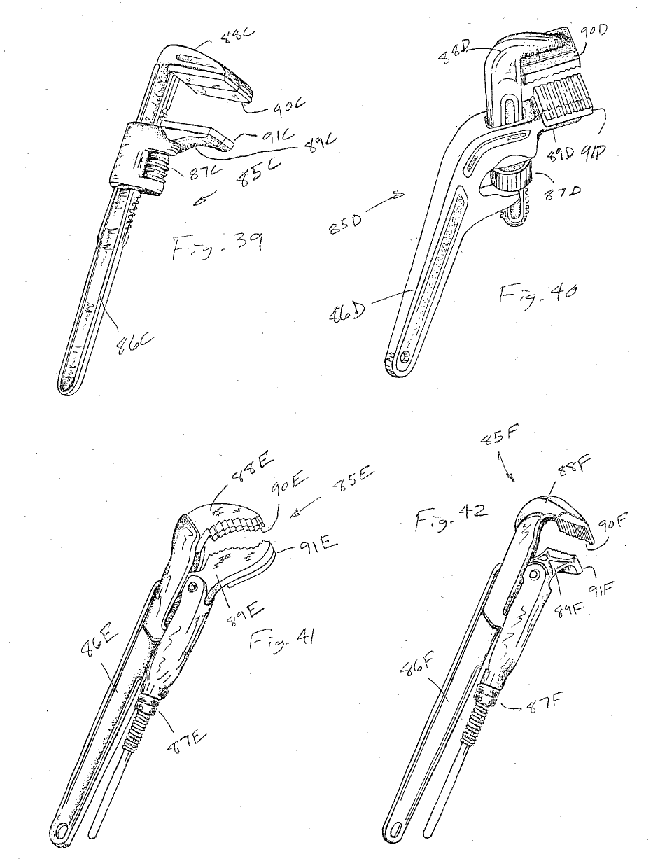

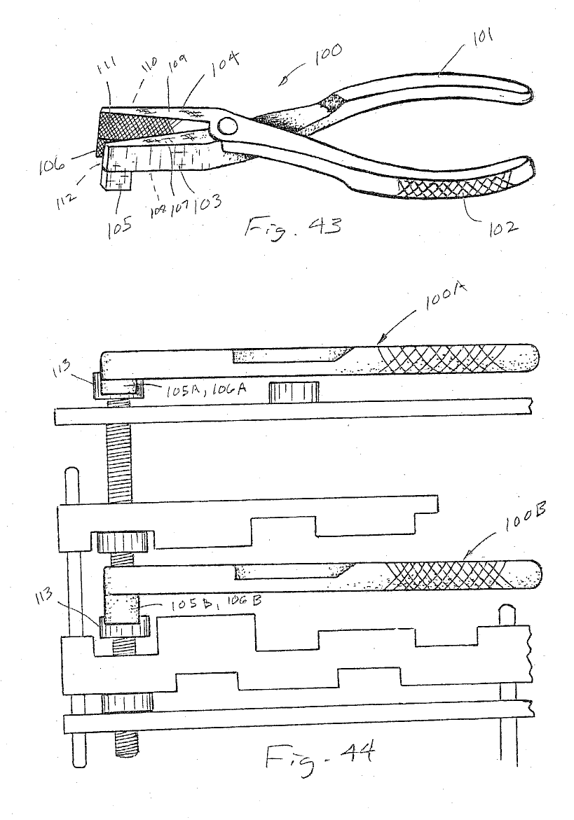

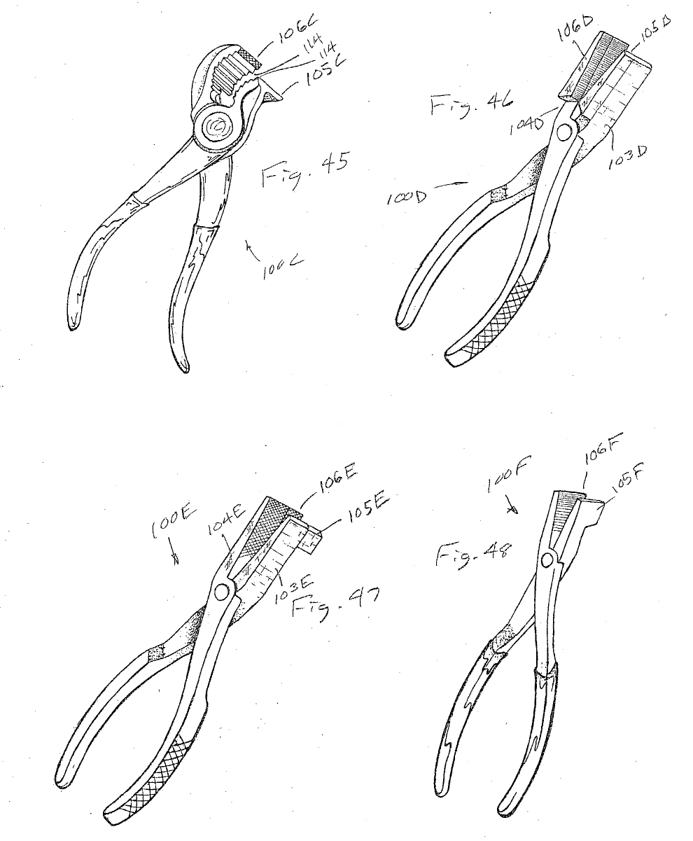

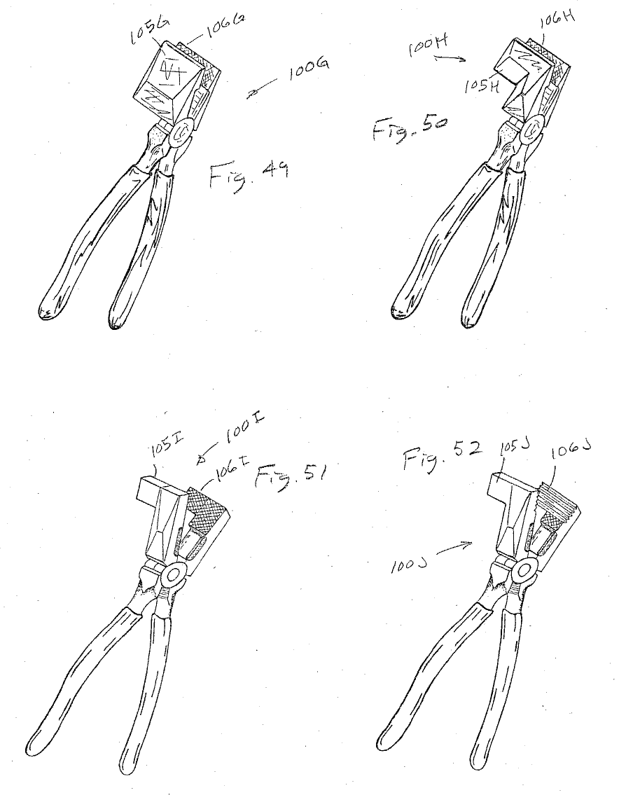

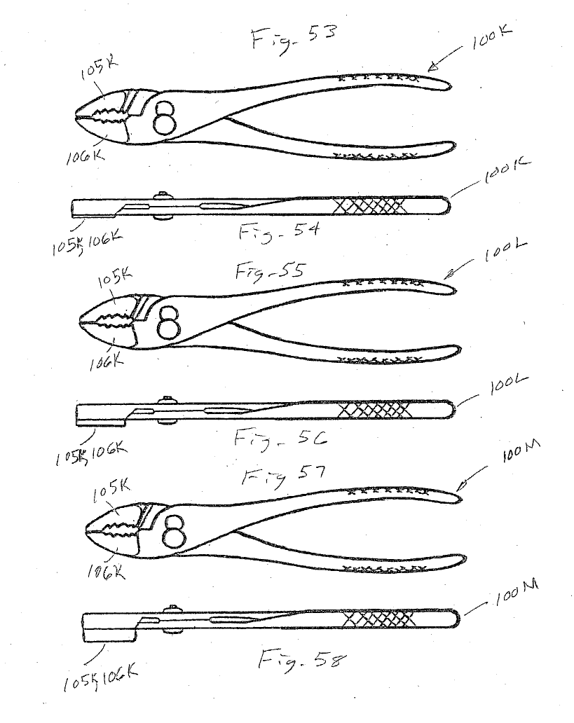

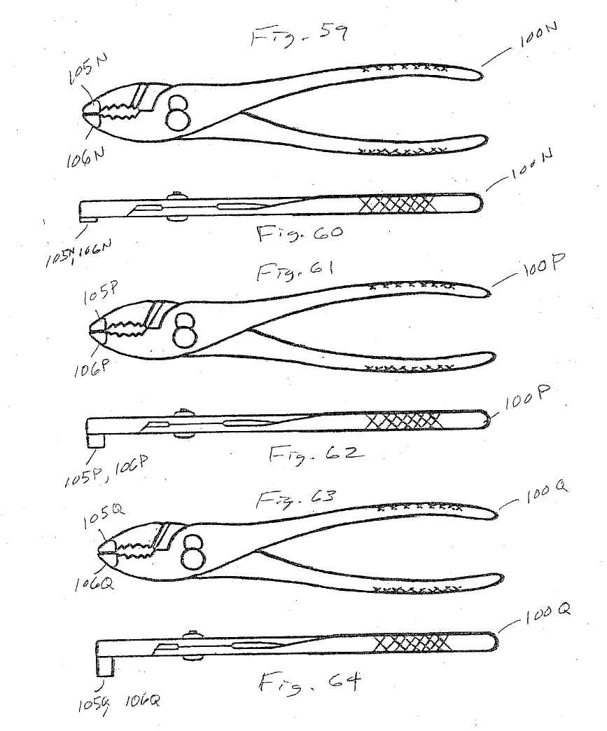

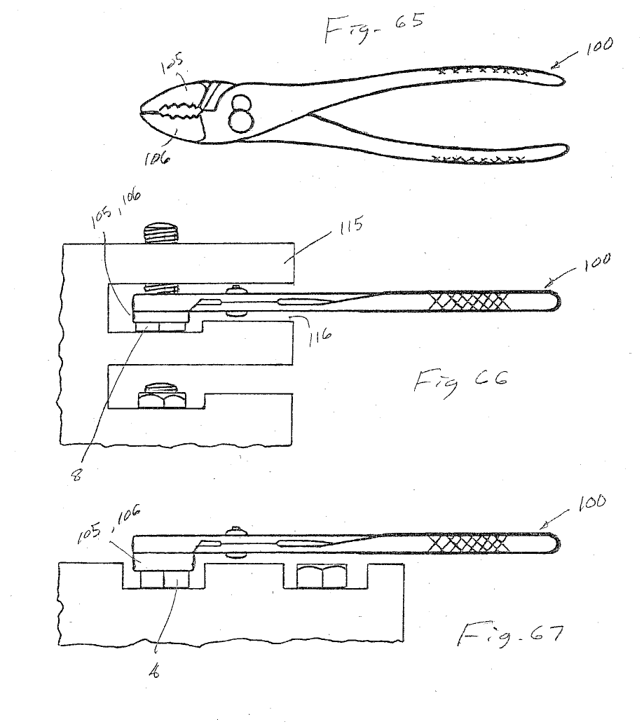

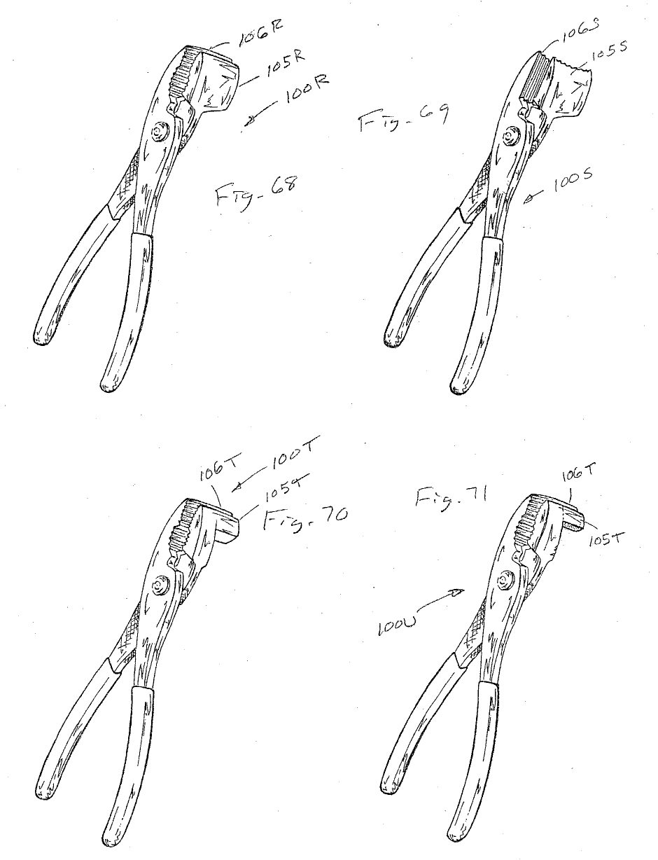

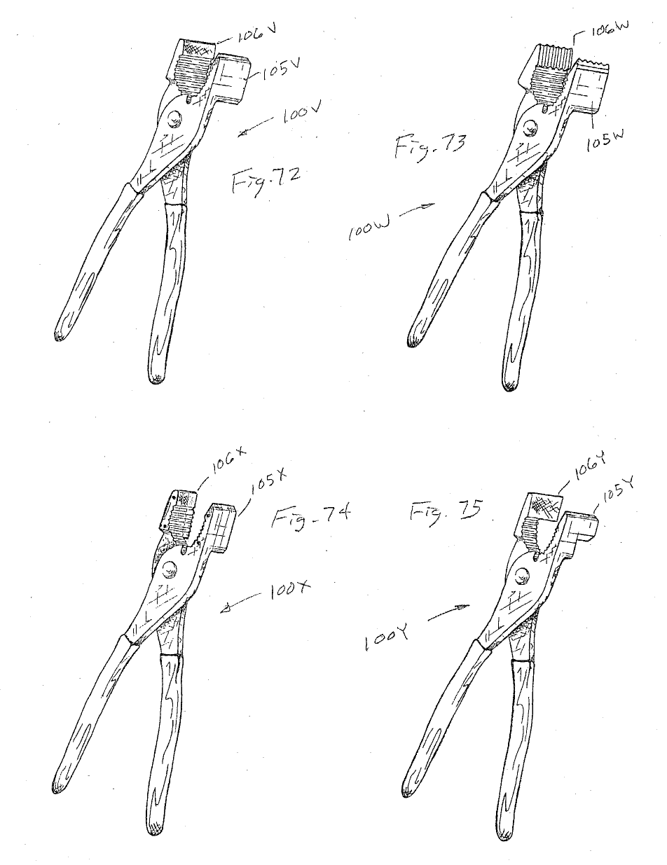

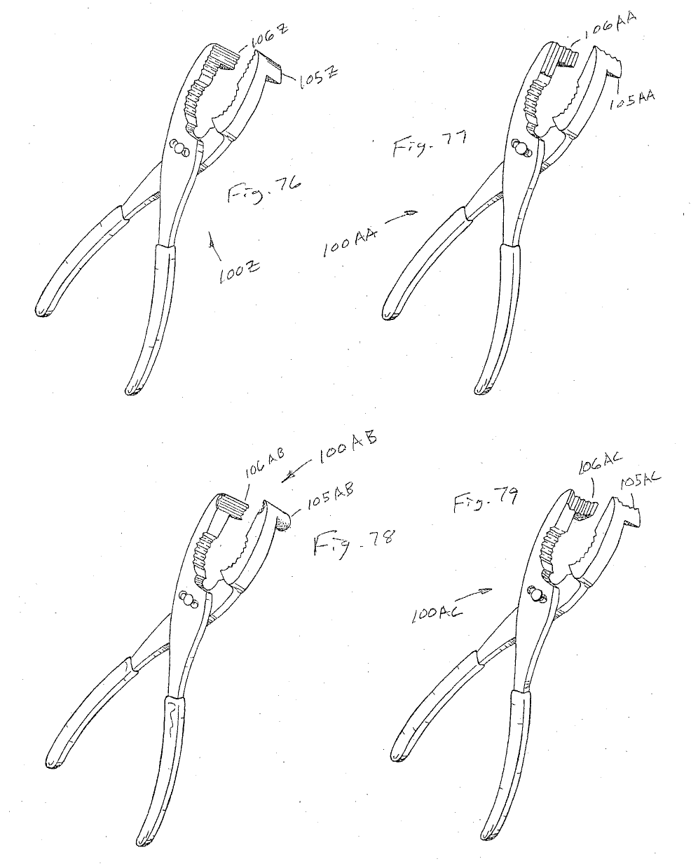

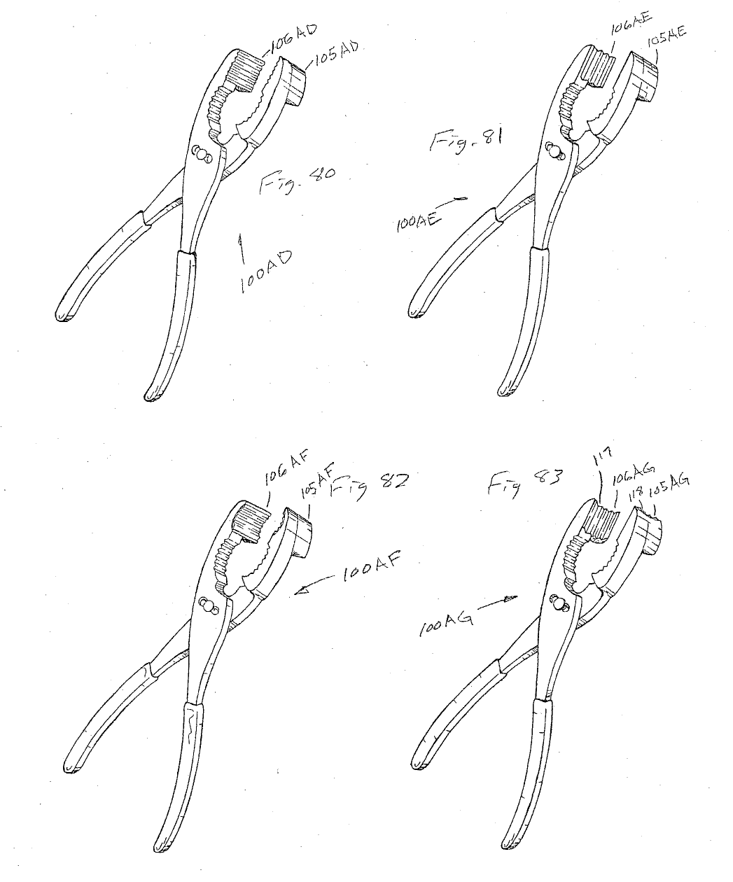

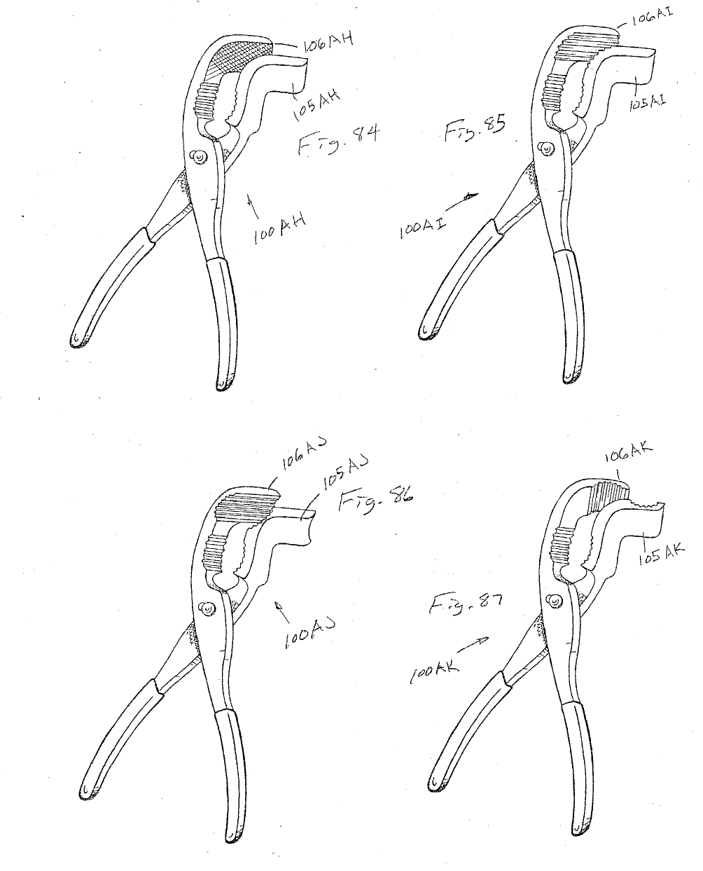

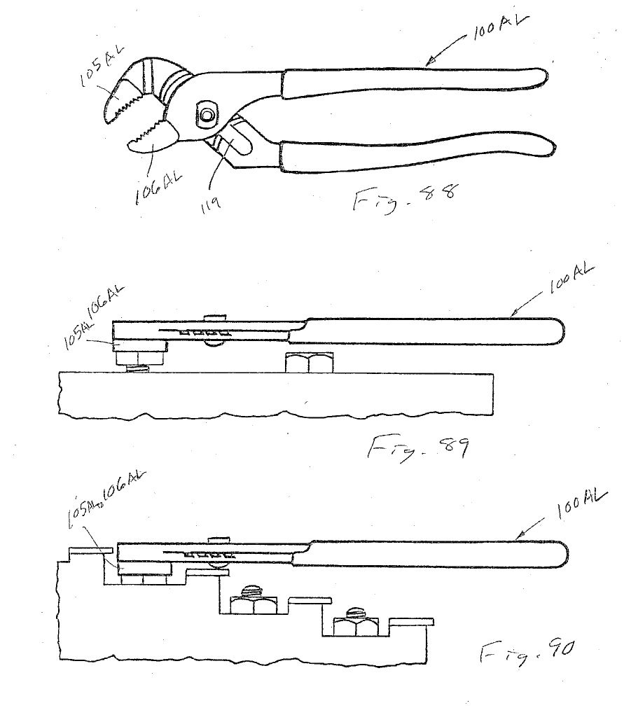

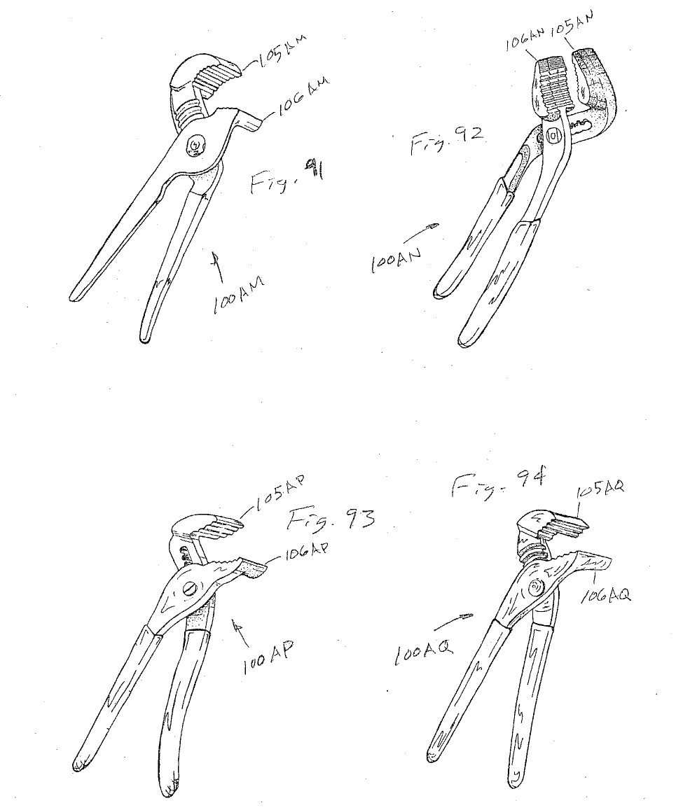

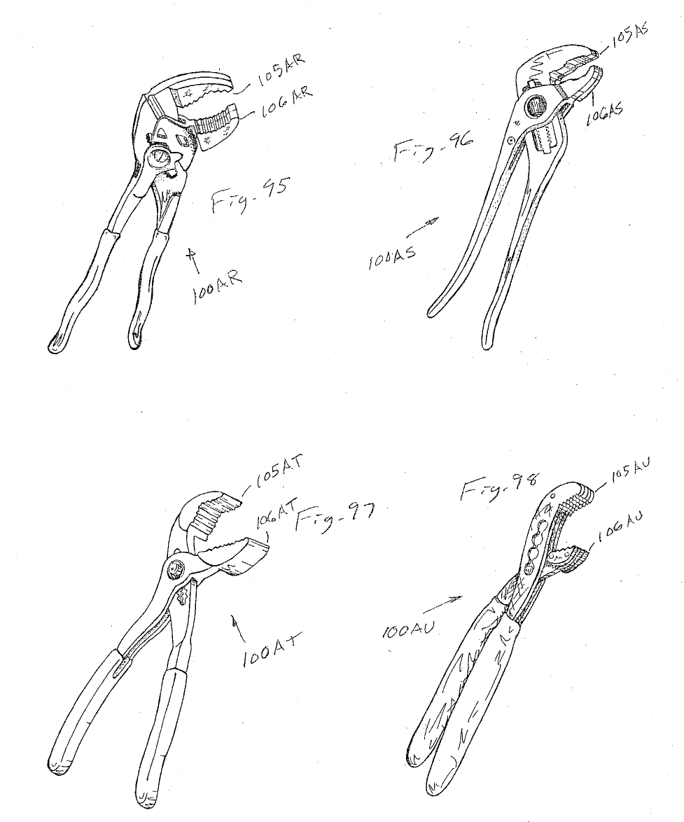

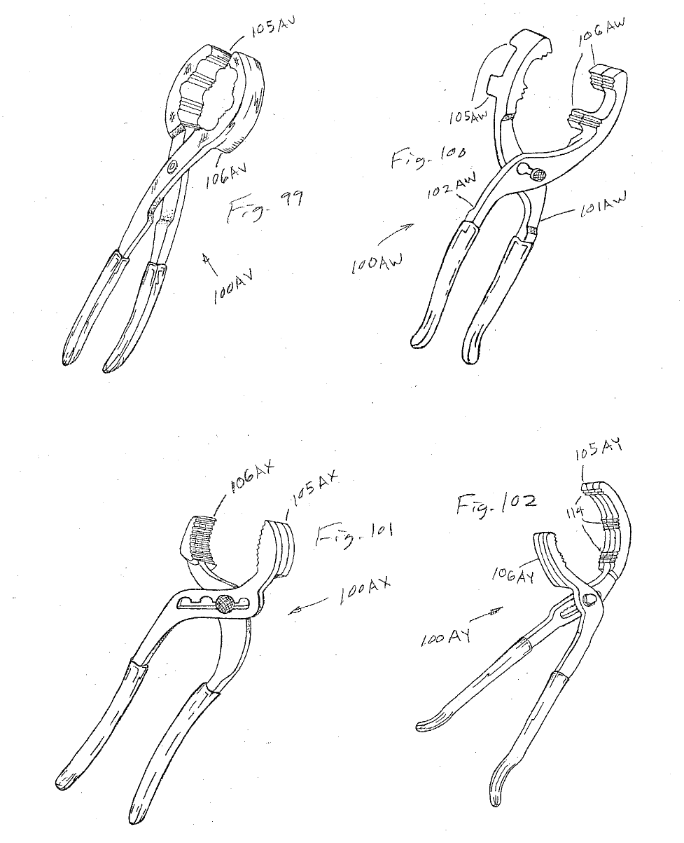

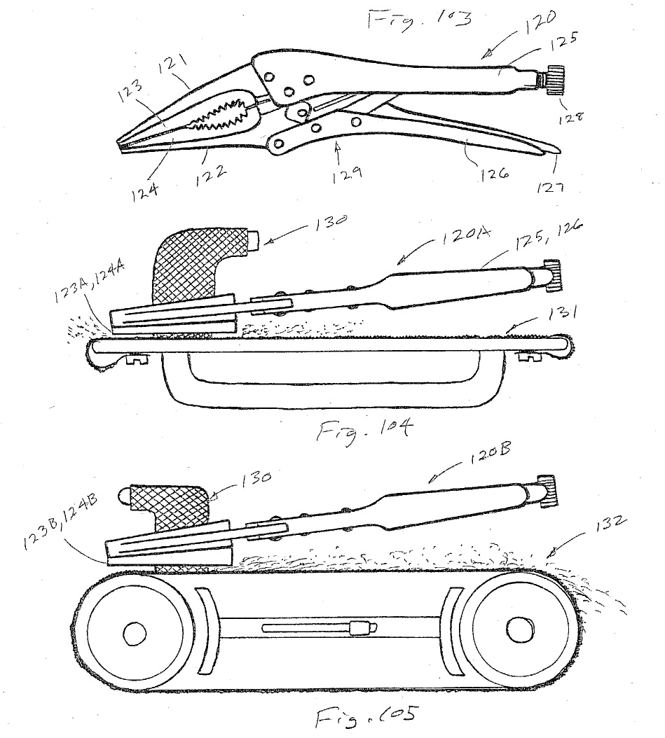

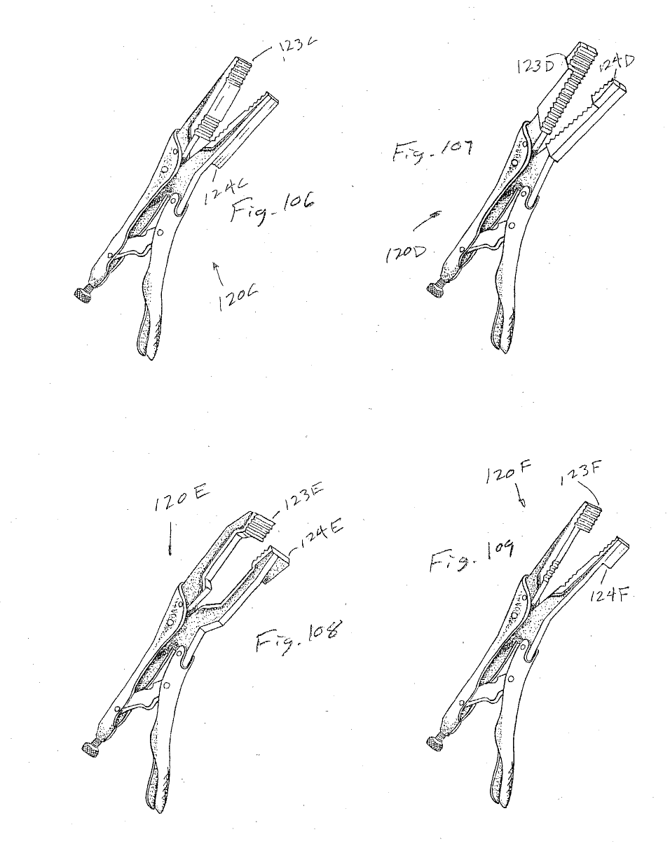

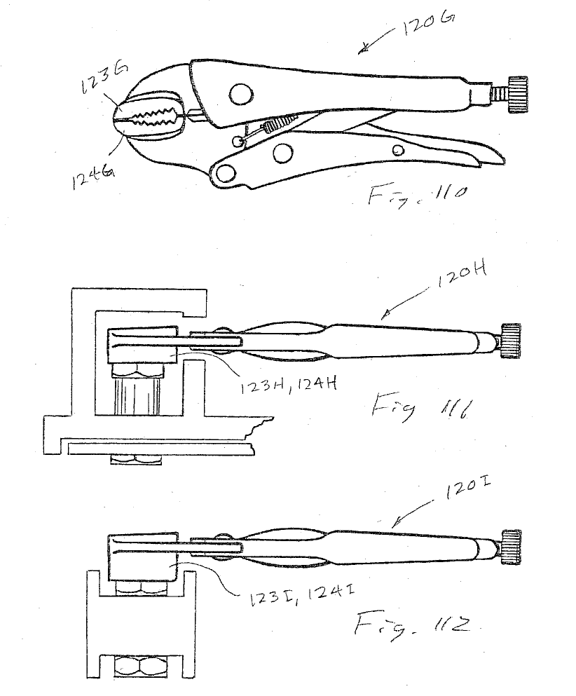

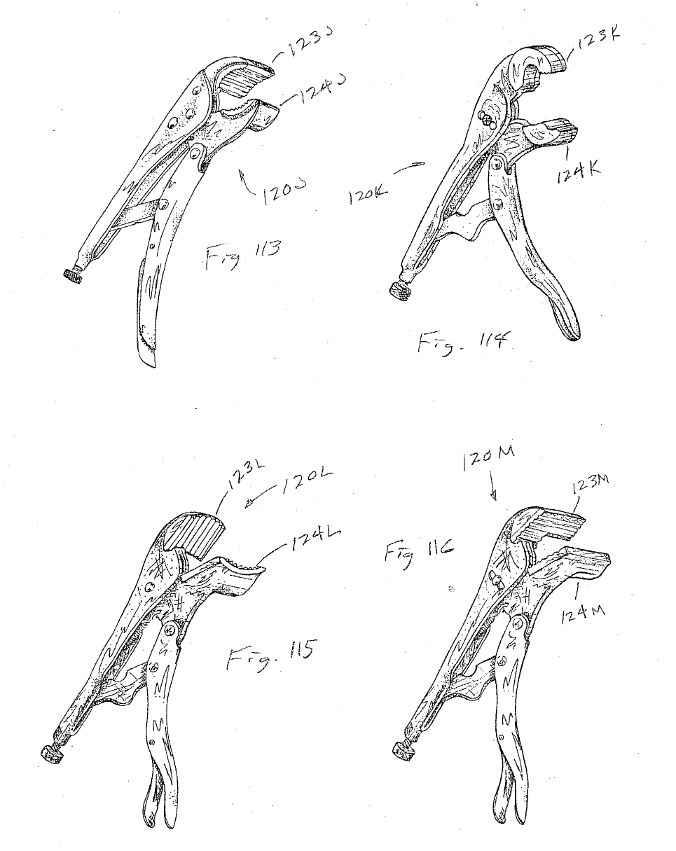

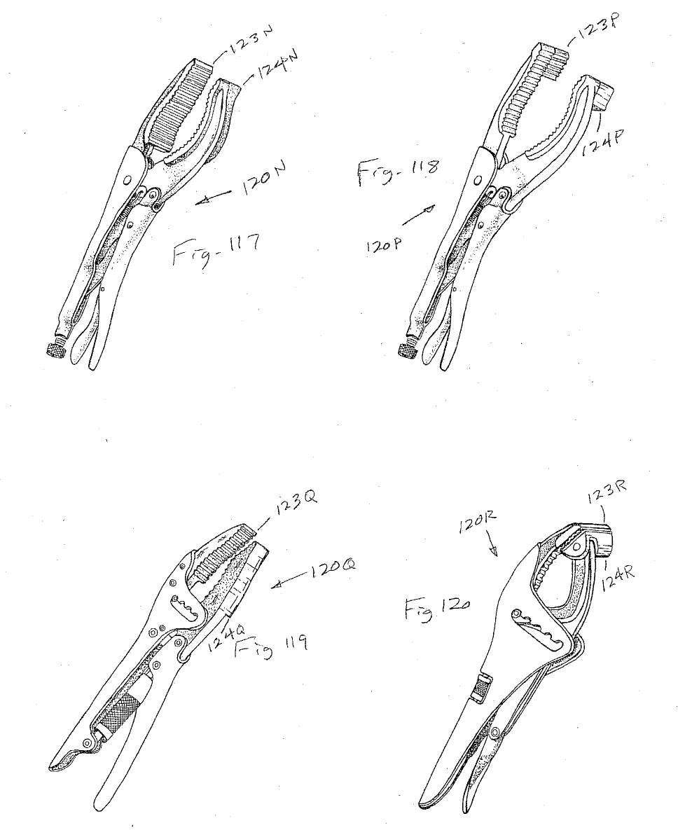

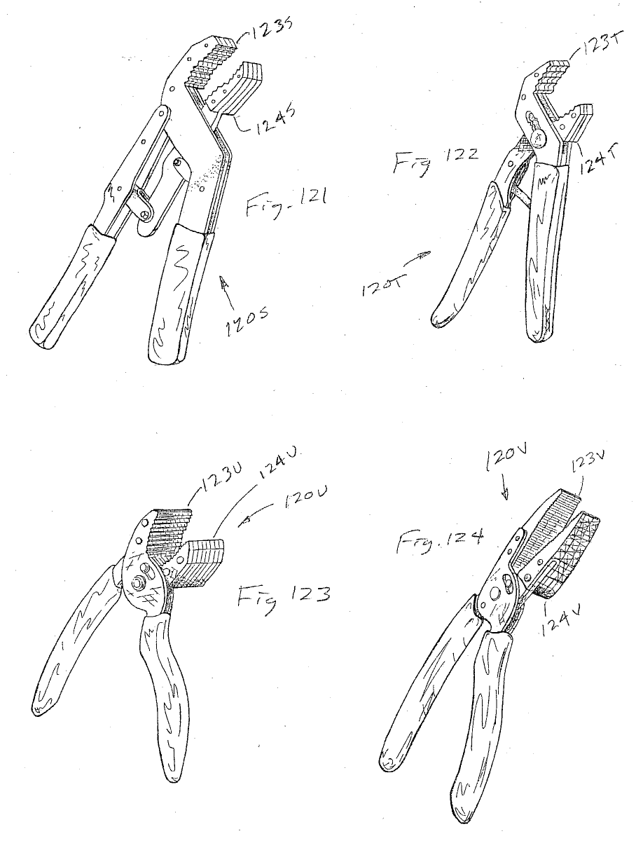

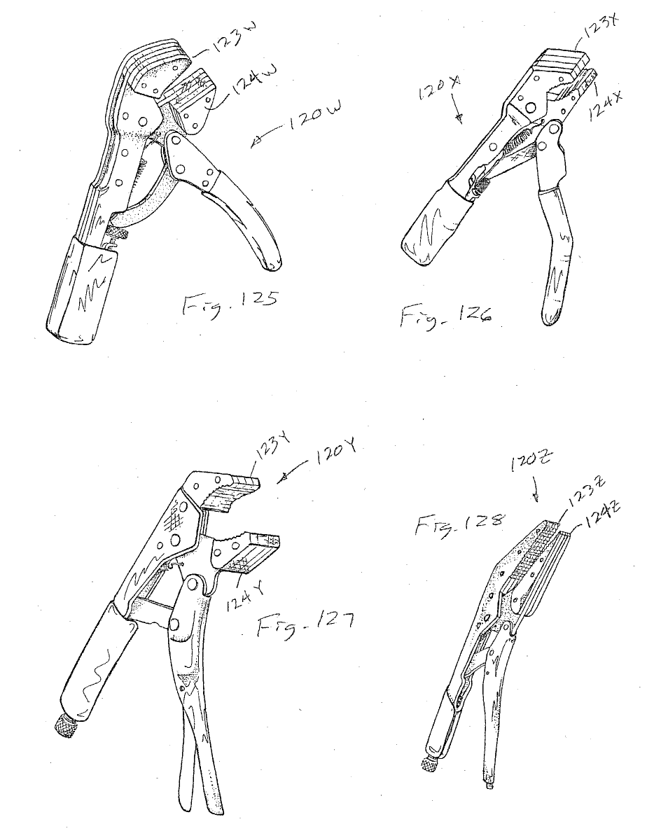

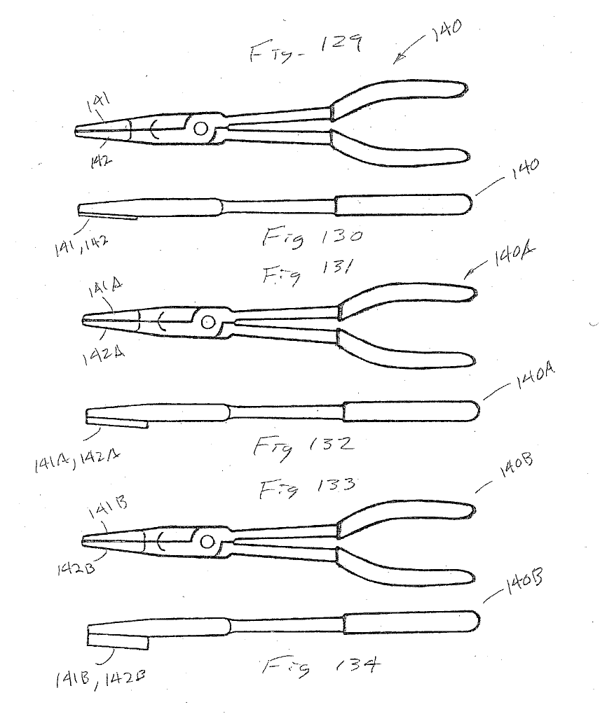

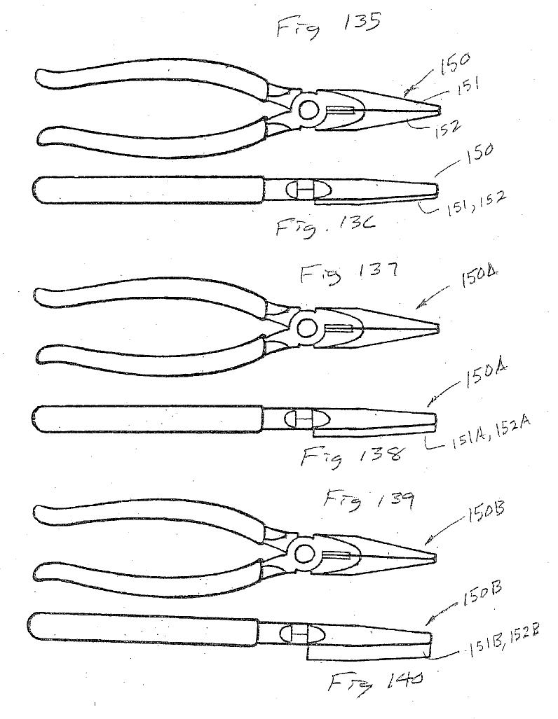

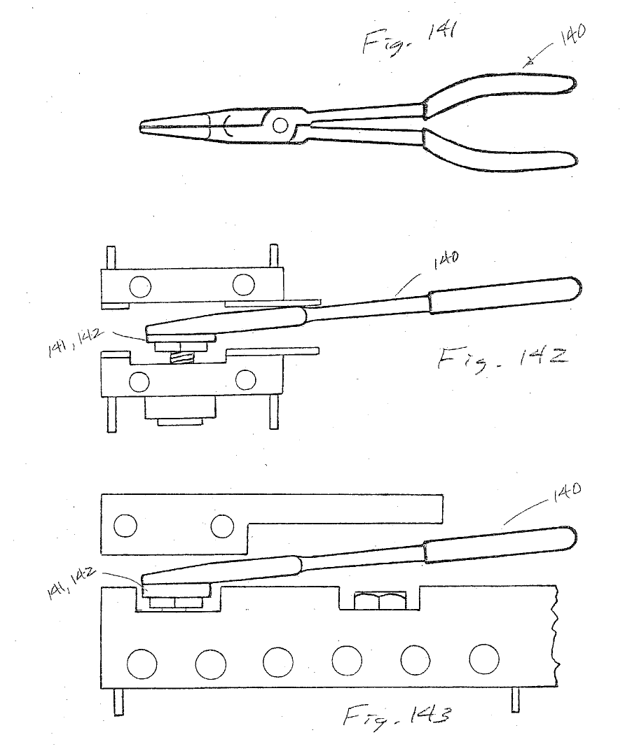

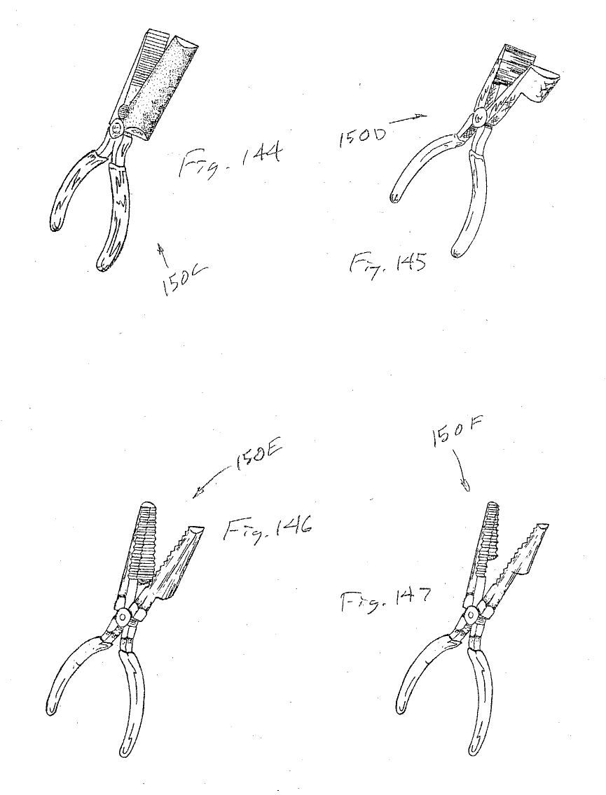

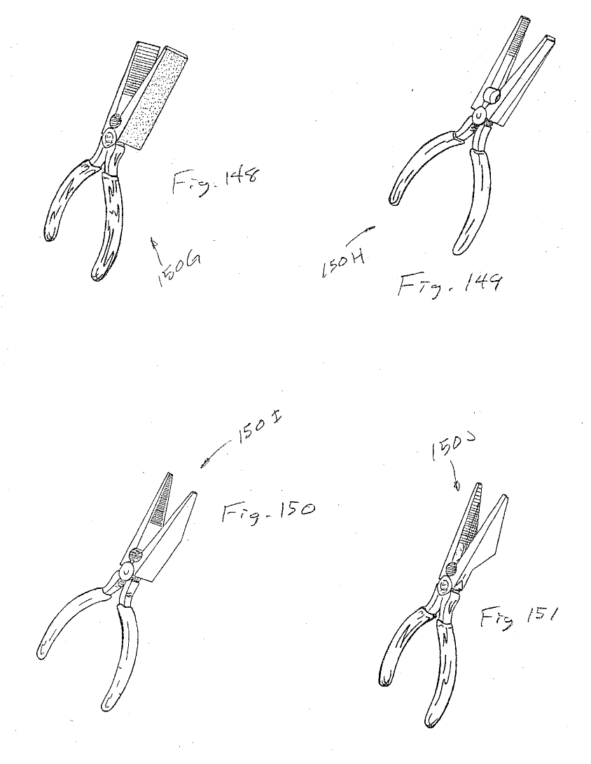

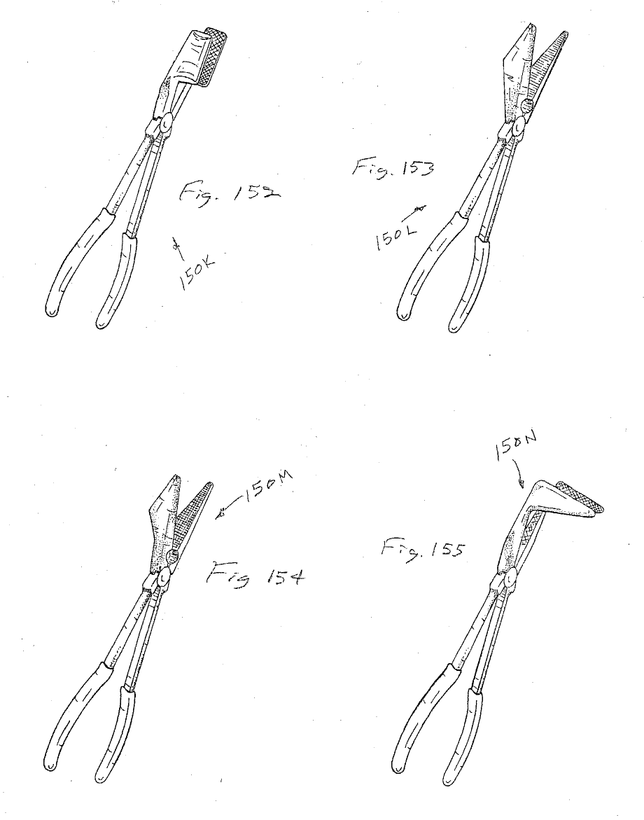

FIGS. 4-7 illustrate further embodiments of the open end wrench. Each of the wrenches include extensions. For example, in the embodiment illustrated in FIG. 4, the wrench is designated 1B, and the extension is designated 5B. The wrenches of FIGS. 5-7 are similarly designated 1C, 1D, and 1E, and the extensions are designated 5C, 5D, and 5E.

FIG. 8 illustrates a wrench 20 including a socket 21 that ratchets relative to the handle 22. However, unlike conventional ratchet wrenches, the socket 21 is permanently affixed to the wrench 20. FIGS. 9 and 10 illustrate alternate embodiments of the socket wrench 20A, and 20B, respectively. The wrenches of FIGS. 9 and 10 include ratcheting sockets 21A and 21B, respectively, that are also permanently affixed to the wrench. FIG. 11 illustrates another wrench with extensions 26 and 27. The wrench 25 includes a movable portion 28 that provides a ratcheting function in use. Although the ratcheting mechanism of the wrench 25 is known, the wrench 25 including extensions 26 and 27 is believed to be novel.

FIG. 12 is a perspective view of a wrench 30 including an end 31 that pivots or rotates relative to the handle 32 of the wrench 30. The wrench 30 includes extensions 33 and 34 that are offset from the center portion 35 of the wrench 30 to provide access to hex head fasteners and the like. FIG. 13 illustrates an alternate embodiment 30A of the wrench of FIG. 12, wherein corresponding parts are designated with the same number including the letter “A”. Similarly, FIG. 14 illustrates another embodiment 30B of the wrench of FIG. 12, wherein corresponding parts are designated with the same number including the letter “B”. FIG. 15 illustrates another embodiment 30C of the wrench of FIG. 12, wherein corresponding parts are designated with the same number including the letter “C”. The wrenches illustrated in FIGS. 12-15 can be utilized to engage fasteners and the like having various size hex heads.

With further reference to FIG. 16, an adjustable open end wrench 40 according to another aspect of the present invention includes a conventional handle portion, and a first jaw portion 42 that is integrally formed with the handle portion 41. A second jaw 43 translates in a known manner along a guide 45 when an adjustment member 44 is moved. However, unlike known adjustable open end wrenches, the wrench 40 includes transverse extensions 46 and 47 on the jaws 42 and 43 to permit the wrench 40 to be utilized to engage hex nuts 8 or the like. As illustrated in FIG. 17 the extensions 46A and 47A may be relatively short. Alternately, the extensions may be relative long as illustrated in FIG. 18, and designated 46B and 47B. As illustrated in FIGS. 17 and 18, the wrench 40A provides access into a channel 8 of an extrusion 49 or the like, or the channel 48A of an extrusion 49A (FIG. 18). The extrusions and channels of FIGS. 17 and 18 are for illustrative purposes only, and do not in any way limit scope of the present invention.

With reference to FIGS. 19-22, the extensions on the jaws may have various lengths and/or configurations. For example, FIG. 19 illustrates another embodiment 40C of the wrench including transverse extensions 46C and 47C. The various parts of the wrenches 40C, 40D, 40E and 40F of FIGS. 19-22 are numbered utilizing the same numbers as the wrench of FIG. 16, except that the letters “C”, “D”, “E”, “F” have been added as shown. Significantly, the transverse extensions 46 and 47 could be positioned adjacent the tips 50E and 51e as illustrated in FIG. 2.

With reference to FIG. 23, an adjustable wrench 60 according to another aspect of the present invention includes a handle 61 and a head 62. An adjustment member 63 can be utilized to shift the movable socket part 64, thereby enabling the wrench 60 to engage threaded fasteners having various size hex heads or the like. The wrench 60 includes a first transverse extension 65 that is integrally formed with the head 62. A second extension 66 is formed on the movable socket part 64. The wrenches 60A, 60B, and 60C of FIGS. 24-26 also include transverse extensions, and the parts corresponding to the wrench of FIG. 23 are similarly numbered, except that the numbers “A”, “B”, “C”, have been added to the part numbers.

FIG. 27 illustrates a pipe wrench 70 including a conventional handle portion 71. A first jaw portion 72 is integrally formed with the handle 71, and includes a plurality of serrations or teeth 73. A second jaw portion 74 moves relative to the first jaw portion 72 via a movable adjustment member 75 in a known manner. However, unlike known pipe wrenches, the wrench 70 includes first and second transverse extensions 76 and 77. As illustrated in FIGS. 29-32, the transverse extensions may have varying lengths to accommodate various applications. With further reference to FIG. 34, the pipe wrench 70 may utilized to engage a cap 79 of a pipe assembly 78 that is obstructed by a building structure 80. Similarly, with reference to FIG. 35, the wrench 70 may be utilized to engage a cap 79 of a pipe assembly 82, wherein access to the cap 79 is at least partially blocked by a floor structure 81 of a building.

With further reference to FIG. 36, another embodiment 85 of a pipe wrench according to the present invention includes a conventional handle 86 and adjustment mechanism 87 of a known type. The wrench 85 includes first and second jaws 88, 89, respectively. The jaws include first transverse extensions 90 and second transverse extensions 91. With further reference to FIG. 37, a first embodiment 85A of the wrench of FIG. 36 includes extensions 90A and 91A that can be utilized to engage a cap 94 on a pipe assembly 92 that is partially blocked by a building floor structure 93. Similarly, another embodiment 85B of the pipe wrench of FIG. 36 may be utilized to engage a fitting 97 that connects a pipe 98 to a sink 95, wherein access to the fitting 97 is at least partially blocked by a board or other structure 96. Alternate embodiments 85C, 85D, 85E and 85F are illustrated in FIGS. 39-42. The pipe wrenches illustrated in FIGS. 39-42 each include extensions designated 90 and 91, except that the letters “C”, “D”, “E”, and “F”, have been added to distinguish between the various embodiments.

With further reference to FIG. 43, a pliers 100 according to another aspect of the present invention includes elongated rigid portions 101 and 102 that are pivotally interconnected, and include jaw portions 103 and 104. Jaw portion 103 includes a first side face 107, and a second side face 108. The side faces 107 and 108 are generally planar, and parallel to one another. The second member 104 of the pliers 100 similarly includes parallel first and second side faces 109 and 110, respectively. Jaw 103 includes a transverse extension 105, and jaw 104 includes a transverse extension 106. The jaws 103 and 104 each include gripping surfaces designated 111 and 112, respectively. In the embodiment illustrated in FIG. 43, the gripping surfaces 111 and 112 include a knurled surface that is generally planar. However, as described in more detail below, the gripping surfaces 111 and 112 may include serrations or teeth, and may be curved in a variety of configurations. As illustrated in FIG. 44, the extensions 105 may be relatively short as designated 105A and 106A in a first embodiment 100A of the pliers. Alternately, the extensions may be longer as illustrated in the embodiment 100B of the pliers. The extensions can be utilized to engage a fastener 113 or the like.

With further reference to FIG. 45, another embodiment 100C of the pliers according to another aspect of the present invention includes extensions 105C and 106C, and includes a plurality of serrations or teeth 114 to provide an engagement gripping surface. Embodiments 100D-100Q of the pliers are illustrated in FIGS. 46-64. As shown in this pictures, the extensions 105 and 106 can be provided in a variety of configurations. For example, with specific reference to FIG. 46, extensions 105D and 106D are relatively long, and generally have the same contour as the jaws 103D and 104D. Alternately, as illustrated in FIG. 47, extensions 105E and 106E extend from the tips of the jaws 103E and 104E to provide access in other applications as required. Extensions of various configurations are further illustrated in the above-identified figures.

With further reference to FIGS. 66 and 67, the pliers 100 may be utilized to grip a hex head 8 or the like that is positioned within a channel 116 of an extrusion 115 or the like. Although the pliers illustrated in FIGS. 66 and 67 are designated 100, as would be readily apparent to one skilled in the art that all of the above-identified embodiments of the pliers according to the present invention could be utilized as required for a particular application.

Further embodiments of the pliers including transverse offsets are illustrated in FIGS. 68-87. The various embodiments of the pliers are designated “100”, with the letters “R”, etseq. utilized to designate the various embodiments of the pliers and the extensions 105 and 106. The transverse extensions may include teeth curved in the manner illustrated in FIG. 78, or in the manner illustrated in FIG. 79. Furthermore, the extensions may include a curved end portions 117 and 118 as illustrated in the embodiment of the FIG. 83.

An adjustable pliers 100AL is illustrated in FIG. 88. The pliers 100AL includes an elongated slot 119 to provide adjustment in a known manner. The pliers 100AL may be utilized to grip fasteners in the manner illustrated in FIGS. 89 and 90.

Additional embodiments of the pliers including the transverse extensions are illustrated in FIGS. 91-102. These embodiments of the pliers illustrate a range of transverse extensions that may be utilized in a variety of applications. For example, the pliers of FIG. 99 may be utilized to grasp items having a relatively large size. Furthermore, as illustrated in FIG. 100, the transverse extensions may include multiple portions. For example, the pliers member 101AW may include two separate transverse extensions 105AW, and a second pliers member 102AW may include two transverse extensions 106AW. As illustrated in FIG. 102, the extensions may also include three separate portions having teeth 114 as required for a particular application.

With reference to FIG. 103, a locking pliers 120 according to another aspect of the present invention. The locking pliers 120 includes a locking mechanism 129 of a known type, and conventional handle portions 125 and 126. The release mechanism 127 and adjustment member 128 of the locking mechanism 129 provide for adjustable locking of jaws 121 and 122 around various objects. Jaws 121 and 122 include transverse extensions 123 and 124.

As illustrated in FIG. 104, the locking pliers 120 can be utilized to hold an object 130 for manual sanding on a sander 131. The transverse extensions 123 and 124 permit the object 130 to be brought into contact with the sander 131, with the handle portions 125 and 126 positioned away from the sander 131 to prevent injury to a user. Similarly, as illustrated in FIG. 105, another embodiment of the locking pliers 120B may be utilized to sand an object 130 on a power sander 132.

As illustrated in FIGS. 106-109, various embodiments 120C-120F of the locking pliers may include a variety of transverse offset portions to accommodate a wide variety of applications.

As illustrated in FIGS. 110-112, embodiments 120G, 120H and 1201 of the locking pliers includes transverse extensions 123 and 124 having various lengths that can be utilized to grip various objects, even if access is restricted.

As illustrated in FIGS. 113-120, various embodiments 120J-120Z of the locking pliers include various transverse extensions 123J and 124J through 123Z and 124Z.

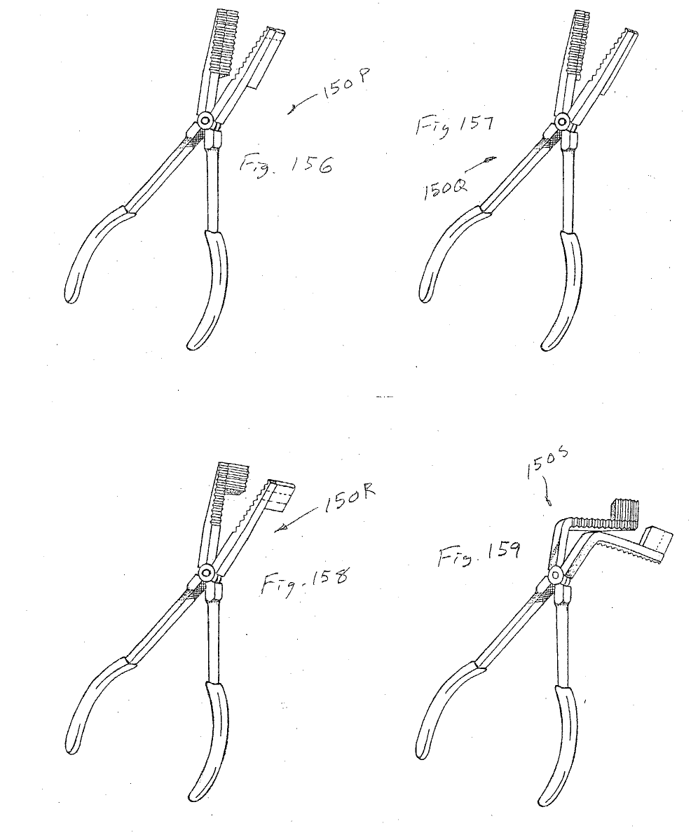

FIGS. 129-134 illustrate various embodiments 140, 140A and 140B of a pinch nose pliers including transverse extensions 141 and 142. Similarly, FIGS. 135-140 illustrate another type of pliers 150 including transverse extensions 151 and 152. FIGS. 142 and 143 illustrate the pinch nose pliers 140 in use, and illustrate use of the transverse extensions 141 and 142 to grip a fastener or the like. FIGS. 144-159 illustrate further embodiments 150C-150S of the pliers including transverse extensions.

The wrench and pliers of the present invention include transverse portions for engaging fasteners or the like in applications having limited access, and also permit a user to torque a fastener or the like without the user's hands contacting other portions of the fixture in a manner that would otherwise cause injury.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A one-piece open end wrench, comprising:
a conventional handle adapted to be grasped by a user, said handle defining a centerline, and said wrench including an integral head at a first end of said handle, said head including a pair of spaced apart members extending from said first end and having parallel inner faces that are spaced apart to engage flat surfaces of fasteners, said head having a first side face spaced a first distance from said centerline; and including:
an extension wall extending from said head, generally transverse to said centerline, said extension wall having a generally U-shaped cross sectional shape and having an end defining a second side face that is spaced a second distance from said centerline, wherein said second distance is substantially greater than said first distance, said extension wall defining at least a portion of said parallel inner faces such that said extension wall provides an offset extension adapted to engage fasteners.

2. The open-end wrench of claim 1, wherein:
said wrench is made of a forged metal material.

3. The open-end wrench of claim 2, wherein:
said head comprises a first head; and including:
a second head at a second end of said handle, said second head having parallel opposite side faces and having a U-shaped profile and defining a thickness that is substantially uniform over the entire U-shaped profile.

4. A pliers for gripping objects, comprising:
first and second elongate rigid members, each having a handle portion at first ends thereof, and engagement gripping jaws having tips at second ends of said first and second rigid members, each rigid member defining an intermediate portion between said handle portion and said engagement gripping jaws, said first and second rigid members pivotably interconnected about a pivot axis at said intermediate portion;
said first rigid member defining a first side face transverse to said pivot axis, said first side face extending to said tip of said jaw, said first rigid member defining a generally planar second side face parallel to said first side face and a first gripping surface on said engagement gripping jaw extending generally parallel to said pivot axis, said first rigid member including an extension at said tip extending transversely from said second side face generally parallel to said pivot axis, said first gripping surface extending from said planar side face to an end of said extension, said second rigid member having an extension and defining a second gripping surface on said extension configured to engage said first gripping surface at ends of said extensions.

5. The pliers of claim 4, wherein:
said gripping surfaces are curved.

6. The pliers of claim 5, wherein:
said first and second gripping surfaces include a plurality of elongated teeth extending parallel to said pivot axis.

7. The pliers of claim 5, wherein:
said first and second gripping surfaces include a plurality of teeth extending transverse to said pivot axis.

8. The pliers of claim 4, wherein:
said pliers comprise pinch nose pliers.

9. The pliers of claim 4, wherein:
said pliers comprise lineman's pliers.

10. An adjustable open end wrench, comprising:
an elongated member having a conventional handle and a first jaw at a first end, said first jaw having first and second opposite side faces defining a first thickness therebetween, and a first gripping surface extending between said opposite side faces, said elongated member including a linear guide;
a second jaw slidably engaging said guide and having a second gripping surface that is generally parallel to said first gripping surface, said second jaw having first and second opposite side faces that define a second thickness therebetween that is approximately the same as said first thickness;
an adjustment member engaging said second jaw and providing controlled linear translation of said second jaw along said guide to provide variable spacing between said first and second gripping surfaces; and
said first and second jaws each defining a tip portion and including an extension extending transversely from said tip portion outwardly from said side faces, said extensions forming at least a portion of said first and second gripping surfaces.

11. The adjustable open end wrench of claim 10, wherein:
said extensions define sidewalls extending transverse from said first side faces.

12. The adjustable open end wrench of claim 11, wherein:
said sidewalls extend outwardly a distance that is approximately equal to said first thickness.

13. The adjustable open end wrench of claim 10, wherein:
said first and second gripping surfaces are planar.

14. The adjustable open end wrench of claim 13, wherein:
said first and second jaws have curved outer surfaces that intersect said gripping surfaces to form a profile having a pointed tip portion, said extensions forming at least a portion of said curved outer surfaces.

15. The adjustable open end wrench of claim 14, wherein:
said linear guide includes a flat guide surface on said elongated member that is transverse to said first and second gripping surfaces, said extension having a planar side wall substantially parallel to said flat guide surface.

16. The adjustable open end wrench of claim 15, wherein:
said planar side wall of said extension is spaced apart from said flat guide surface.

17. The adjustable open end wrench of claim 10, wherein:
said wrench comprises a pipe wrench.

18. The adjustable open end wrench of claim 17, wherein:
said first and second gripping surfaces include a plurality of teeth.

19. A pliers for gripping objects, comprising:
first and second elongated member, each forming a handle portion adjacent a first end, and jaws at a second end, said first and second elongated members pivotably interconnected about a pivot axis such that said jaws move between open and closed positions;
each jaw including a first portion extending generally linearly from said pivot axis, each jaw having an intermediate portion extending transversely from said first portion, said intermediate portion defining a thickness having a maximum size, each jaw having a tip portion extending in approximately the same direction as said first portion, and defining spaced apart side edges extending generally parallel to said first portion, said side edges defining a distance therebetween that is substantially greater than said maximum size of said intermediate portion.

20. An adjustable open end wrench, comprising:
an elongated member having a conventional handle and a first jaw at a first end, said elongated member including a linear guide and having first and second opposite sides, said first jaw having a first gripping surface extending between said opposite sides;
a second jaw slidably engaging said guide and having a second gripping surface that is opposed to said first gripping surface, said second jaw having first and second opposite sides that define a second thickness;
an adjustment member engaging said second jaw and providing controlled linear translation of said second jaw along said guide to provide variable spacing between said first and second gripping surfaces; and
said first and second jaws each including a transverse extension forming at least a portion of said first and second gripping surfaces, at least one of first sides of said elongated member and said second jaw having a portion defining a plane of maximum width, said transverse extensions extending substantially beyond said plane of maximum width.

21. An adjustable closed end wrench, comprising:
an elongated member having a conventional handle defining an axis and having a head at a first end thereof having an enlarged opening therethrough, said head defining first and second opposite side faces;
an adjustment member movably engaging said elongated member adjacent said enlarged opening;
a fastener-engaging member having at least a portion thereof positioned in said enlarged opening and operably engaging said adjustment member such that said fastener-engaging member shifts upon movement of said adjustment member;
said elongated member and said fastener-engaging member each including a transverse extension extending away from said first side face, said transverse extensions defining opposed inner surfaces having angled portions adapted to fit closely around a fastener having a hexagonal shape.
